(19) United States
(12) Patent Application Publication
(10) Pub. No.: US 2018/0011249 A1
(43) Pub. Date: Jan. 11, 2018

(54) FIBER-TO-WAVEGUIDE COUPLERS WITH ULTRA HIGH COUPLING EFFICIENCY AND INTEGRATED CHIP WAVEGUIDES INCLUDING THE SAME

(71) Applicant: University of Maryland, College Park, MD (US)

(72) Inventors: Tiecheng Zhu, Hyattsville, MD (US); Mario Dagenais, Chevy Chase, MD (US); Sylvain Veilleux, Chevy Chase, MD (US)

(73) Assignee: University of Maryland, College Park, MD (US)

(21) Appl. No.: 15/646,814

(22) Filed: Jul. 11, 2017

Related U.S. Application Data
(60) Provisional application No. 62/360,811, filed on Jul. 11, 2016.
(60) Provisional application No. 62/360,814, filed on Jul. 11, 2016.
(60) Provisional application No. 62/530,441, filed on Jul. 10, 2017.

(51) Int. Cl. G02B 6/12; G02B 6/02; G02B 6/30; G02B 6/36

(52) U.S. Cl. CPC G02B 6/12004; G02B 6/36; G02B 6/02076; G02B 6/305

(57) ABSTRACT

An easy-to-fabricate and highly efficient single-mode optical fiber-to-single-mode optical waveguide coupler having relatively large horizontal and vertical alignment tolerances between the fiber and the waveguide coupler. The waveguide coupler also features ease of end-facet cleaving. The waveguide coupler can be used in ultra-broadband high coupling efficiency applications or other suitable applications. Single-mode on-chip waveguides incorporating such coupler(s) are also provided, as are methods of manufacturing the waveguide coupler and on-chip waveguide.

### CROSS-REFERENCE TO RELATED APPLICATIONS

This application claims the benefit of, and priority to, U.S. Provisional Patent Application No. 62/360,814, titled “High Coupling Efficiency Between a Single Mode Optical Fiber and an On-Chip Planar Single Mode Optical Waveguide,” U.S. Provisional Patent Application No. 62/360,811, titled “Generation of Arbitrary Optical Filtering Function Using Complex Bragg Gratings,” both of which were filed on Jul. 11, 2016, and U.S. Provisional Patent Application No. 62/530,441, titled “Layer Peeling/Adding Algorithm and Complex Waveguide Bragg Grating For Any Spectrum Regeneration and Fiber-to-Waveguide Coupler with Ultra-High Coupling Efficiency,” filed on Jul. 10, 2017. The entire contents of each of these applications is incorporated by reference herein.

### BACKGROUND

### 1. Technical Field

The present disclosure relates to single-mode optical fiber-to-single-mode on-chip optical waveguide couplers and integrated chip waveguides including the same. More specifically, the couplers and waveguides of present disclosure provide ultra-high coupling efficiency (>96%) for an ultra-broadband transmission spectrum, ease of cleaving, and large alignment tolerances.

### 2. Discussion of Related Art

Si3N4/SiO2 waveguides on Si substrates find application, for example, in communications, signal processing, optical sensors, narrow-band filters, photonic band gap engineering, on-chip optical frequency comb generation, short pulse generation, photonic integrated chips for optical interconnects, etc. Compared with Silicon-on-Insulator (SOI) technology which absorbs light below the wavelength of 1.1 μm, Si3N4/SiO2 waveguides have the advantage of a larger transparent spectrum and ultra-low propagation loss. The index contrast between Si3N4 and SiO2, although not as high as that in SOI waveguides, is still large enough to realize reasonably confined waveguides for integration. As for any integration platform, one of the key issues is how to couple light efficiently from an input single-mode optical fiber into a single-mode planar waveguide and, also, from the single-mode planar waveguide to a single-mode output optical fiber.

Generally, there are three major approaches for achieving a high coupling efficiency between a single-mode optical fiber and a single-mode Si3N4/SiO2 waveguide. The first approach utilizes a grating coupler (GC), where light is launched from an optical fiber into a GC at an oblique angle. One drawback of GCs is that these devices are usually not broadband because the phase matching condition can only be met near the central wavelength. Moreover, since a GC typically couples the light from a single-mode optical fiber to a multi-mode waveguide, a subsequent mode-converter is necessary for bringing the light back to a single-mode confined waveguide. Recently, GCs have demonstrated a coupling loss of 0.62 dB with a grating width of 15 μm. However, this grating width needs to be tapered down with an appropriate taper and this leads to additional loss.

The second approach to achieving a high coupling efficiency between a single-mode optical fiber and a single-mode Si3N4/SiO2 waveguide is to use a taper at both ends of the waveguide. Taper-based couplers are inherently more broadband than the GC-based couplers, but typically require a precise end-facet cleaving process to achieve a high coupling efficiency.

The third approach relies on the concept of evanescent-field coupling, where efficient coupling is realized in an overlap region between a single-sided conical tapered fiber and a tapered Si3N4/SiO2 waveguide. However, it is challenging to apply this technique for coupling to multiple devices or for large scale integration applications.

Accordingly, a need exists for easy-to-fabricate, highly efficient single-mode optical fiber-to-single-mode on-chip waveguide couplers and integrated chip waveguides including the same that have relatively large horizontal and vertical alignment tolerances and exhibit cleave position insensitivity. It would also be desirable to provide such couplers and waveguides for use with multiple devices and/or capable of use in large scale integration applications.

### SUMMARY

Provided in accordance with aspects of the present disclosure is a coupler for coupling a single-mode fiber to a single-mode on-chip waveguide. The coupler includes a loosely-confined straight waveguide portion defining a first end configured for positioning adjacent an optical fiber, and a second end. The coupler further includes an adiabatic waveguide mode-converter extending from a first end thereof at the second end of the loosely-confined straight waveguide portion to a second end thereof. The second end of the adiabatic waveguide mode-converter is configured for positioning adjacent a more-confined waveguide core. The adiabatic waveguide converter tapers from the second end to the first end thereof and is configured to serve as a transition between the loosely-confined straight waveguide portion and the more-confined waveguide core.

In an aspect of the present disclosure, the coupler exhibits a coupling efficiency of at least 96%.

In another aspect of the present disclosure, the loosely-confined straight waveguide portion maintains efficiency within a cleave position range of ±200 μm.

In still another aspect of the present disclosure, the coupler defines at least one of a vertical alignment tolerance or a horizontal alignment tolerance of at least 3.8 μm.

In yet another aspect of the present disclosure, the loosely-confined straight waveguide portion and the adiabatic waveguide mode-converter are formed from Si3N4. The loosely-confined straight waveguide portion and the adiabatic waveguide mode-converter may be disposed between top and bottom SiO2 cladding layers and, in aspects, the bottom SiO2 cladding layer is disposed on an Si substrate.

An integrated chip optical waveguide provided in accordance with the present disclosure includes a more-confined waveguide core and a first coupler disposed at an end of the more-confined waveguide core. The first coupler may include any of the aspects and/or features of the coupler noted above or otherwise detailed herein.

In aspects of the present disclosure, the integrated chip optical waveguide further includes a second coupler disposed at an opposite end of the waveguide core. The second coupler may include any of the aspects and/or features of the coupler noted above or otherwise detailed herein.

A system provided in accordance with the present disclosure includes an output optical fiber, an input optical fiber, and an integrated chip optical waveguide disposed between the output optical fiber and the input optical fiber. The integrated chip optical waveguide may include any of the aspects and/or features of the integrated chip optical waveguide noted above or otherwise detailed herein.

### BRIEF DESCRIPTION OF THE DRAWINGS

The above-detailed aspects and features of the present disclosure as well as other aspects and features of the present disclosure will become more apparent from the following detailed description when taken in conjunction with the drawings wherein:

FIG. 1 is a schematic illustration of a system including an input optical fiber, an integrated chip waveguide according to the present disclosure having first and second couplers provided in accordance with the present disclosure, and an output optical fiber;

FIG. 2 is a schematic flow diagram illustrating manufacture of the integrated chip waveguide of FIG. 1;

FIG. 3 is a graph illustrating theoretical coupling efficiencies of the couplers of the present disclosure used between a UHNA3 fiber and a Si3N4/SiO2 waveguide, with different waveguide width and thickness geometries;

FIG. 4 is a graph illustrating theoretical coupling efficiencies versus wavelengths of the couplers of the present disclosure for each of the maximum theoretical coupling efficiency geometries;

FIGS. 5A and 5B are graphs illustrating the theoretical horizontal and vertical alignment tolerances, respectively, of the couplers of the present disclosure used between the UHNA3 fiber and the Si3N4/SiO2 waveguide;

FIG. 6 is a graph illustrating the experimental coupling efficiency (as well as the theoretical coupling efficiency) versus wavelength of the couplers of the present disclosure used between the UHNA3 fiber and a 100 nm thick×900 nm wide Si3N4 waveguide;

FIGS. 7A and 7B are graphs illustrating the experimental (and theoretical) horizontal and vertical alignment tolerances, respectively, of the couplers of the present disclosure used between the UHNA3 fiber and the Si3N4/SiO2 waveguide;

FIG. 8A is a table indicating the maximum theoretical coupling efficiencies of the coupler of the present disclosure at a wavelength of 1550 nm, as determined by a simulation; and

FIG. 8B is a table indicating experimental and simulation alignment tolerances of the coupler of the present disclosure.

### DETAILED DESCRIPTION

The present disclosure provides single-mode fiber-to-single-mode on-chip waveguide couplers and integrated chip waveguides including the same. Although detailed herein as couplers for coupling optical fibers to Si3N4/SiO2 waveguides and Si3N4/SiO2 optical waveguides including the same, one skilled in the art would recognize that the fiber-to-waveguide couplers and integrated chip waveguides of the present disclosure are equally applicable or use in other platforms, material systems, and with other fiber types. For example, and without limitation, the aspects and features of the present disclosure may apply to Si on insulator (SOI), LiNbO3, Silicon oxynitride (SiOxNy) on silicon dioxide (SiO2), and other platforms.

The single-mode fiber-to-single-mode on-chip waveguide couplers and integrated chip waveguides of the present disclosure may find particular applicability for applications such as integrated optical filters (as detailed herein), WDM systems, and quantum information processing; however, the present disclosure is in no way limited to these applications.

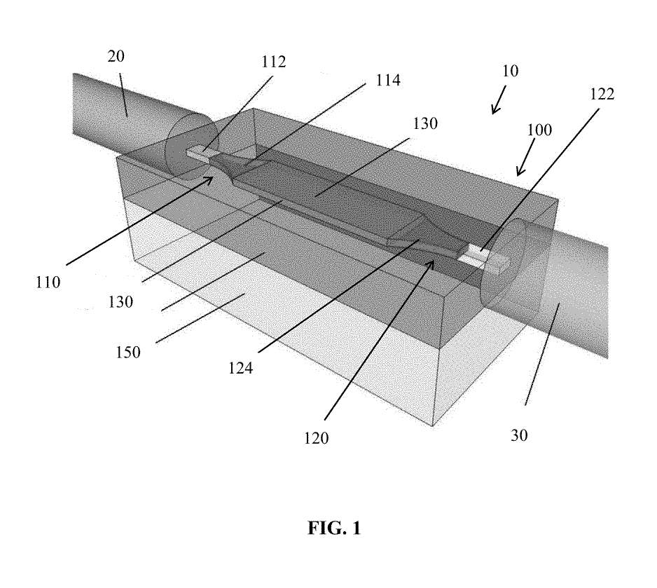

Referring to FIG. 1, a system 10 provided in accordance with the present disclosure includes an input , single-mode optical fiber 20, an output, single-mode optical fiber 30, and an integrated chip optical waveguide 100 operably coupled between the input optical fiber 20 and the output optical fiber 30.

Integrated chip optical waveguide 100 includes first and second couplers 110, 120 disposed on either side of a single-mode waveguide core 130 and configured to couple input optical fiber 20 to waveguide core 130 and waveguide core 130 to output optical fiber 30, respectively. Waveguide core 130 is an Si3N4 core. Integrated chip optical waveguide 100 further includes top and bottom SiO₂ cladding layers 140, and an Si substrate 150 upon which the first and second couplers 110, 120, waveguide core 130, and SiO₂ cladding layers 140 are implemented. Thus, integrated chip optical waveguide 100 is an Si3N4/SiO2 waveguide. Compared with the SOI platform, which absorbs light below 1.1 μm, an Si3N4/SiO2 waveguide is transparent for both the visible and the near-infrared spectra. Having such a large spectral operation range is of particular interest in many areas, such as, but not limited to, sensors and astronomy applications. However, the present disclosure is equally applicable for use with SOI and other platforms.

The waveguide core 130 defines a more-confined configuration, that is, where the optical mode is more confined. The waveguide core 130 may be configured, for example, as a waveguide Bragg grating (WBG), ring resonator, arrayed waveguide grating (AWG), or may define any suitable single-mode structure depending on a particular purpose. The waveguide core 130 may define a thickness of about 100 nm. The width of the waveguide core may be, in embodiments, about 1.5 μm to about 3.5 μm, in other embodiments, from about 2.0 μm to about 3.0 μm or, in still other embodiments, from about 2.5 μm. Other thicknesses and widths are also contemplated.

Each coupler 110, 120 generally includes a loosely-confined straight waveguide portion 112, 122 and an adiabatic waveguide mode-converter 114, 124 defining an adiabatic taper. Each loosely-confined straight waveguide portion 112, 122 is positioned adjacent a corresponding one of the fibers 20, 30 and has a mode profile optimized for maximum coupling with the corresponding fiber 20, 30. More specifically, loosely-confined straight waveguide portions 112, 122 provide an ultra-broadband coupling efficiency over a wide spectrum. The loosely-confined straight waveguides 112, 122 of couplers 110, 120 are configured to be butt-coupled with the corresponding fiber 20, 30, respectively. Compared with other coupling techniques such as GC or evanescent-field coupling, a butt-coupling provides ease-of-alignment and also enables coupling to several devices simultaneously. Unlike evanescent-field coupling, butt-coupling has the benefit of larger fiber-to-waveguide alignment tolerances (in both the vertical and horizontal directions). Compared to GC, the butt-coupling approach has a better wavelength insensitivity.

The loosely-confined straight waveguide portions 112, 122 also allow for ease of end-facet cleaving. That is, because of loosely-confined straight waveguide portions 112, 122, the cleaving position is not that important for realizing the high coupling efficiency. Each loosely-confined straight waveguide portion 112, 122, for example, may defines a length of about 500 +200 μm (that is, about 300 μm to about 700 μm). Cleaving the free ends of the loosely-confined straight waveguide portions 112, 122 to define a length within the above range is sufficient to maintain high efficiency. Thus, minimal cleave position sensitivity is realized. In contrast, most butt-coupled waveguide couplers having nano-sized tapers at the coupling end require cleaving at the end of the taper to within a range of about +10 μm of the target length, which is challenging. The loosely-confined straight waveguide portions 112, 122 may define a width, in embodiments, from about 600 nm to 1200 nm, in other embodiments, from about 750 nm to about 1050 nm, and, in still other embodiments, of about 900 nm, although other suitable widths are also contemplated. The loosely-confined straight waveguide portions 112, 122 may each define a thickness of about 100 nm.

The adiabatic waveguide mode-converters 114, 124 define adiabatic tapers and are positioned adjacent the opposed ends of the waveguide core 130 to serve as transitions between the loosely-confined straight waveguides 112, 122 and the more-confined waveguide core 130. The length of each adiabatic waveguide mode-converter 114, 124 is selected, in embodiments, to be within the range of 250 μm to about 750 μm, in other embodiments, from about 400 μm to about 600 μm, and in still other embodiments, of about 500 μm. The adiabatic waveguide mode-converters 114, 124 are configured such that mode conversion occurs gradually along the taper of the adiabatic waveguide mode-converters 114, 124 with minimal loss. As can be appreciated, the width of each adiabatic waveguide mode-converters 114, 124 at the narrow end thereof approximates the widths of the corresponding loosely-confined straight waveguide 112, 122, while the width of each adiabatic waveguide mode-converters 114, 124 at the wider end thereof approximates the width of the waveguide core 130. The adiabatic waveguide mode-converters 114, 124 may each define a thickness of about 100 nm.

Continuing with reference to FIG. 1, the lengths of the loosely-confined straight waveguides 112, 122 and the adiabatic waveguide mode-converters 114, 124, within the above-noted ranges, are selected to maintain a small propagation loss. For example, considering a length of 300 μm for each loosely-confined straight waveguide 112, 122, a length of 500 μm for each adiabatic waveguide mode-converter 114, 124, and a typical propagation loss of <2 dB/cm, the overall propagation loss for each coupler 110, 120 is <0.16 dB, which is tolerable for most applications. Of course, the lengths (and other dimensions) of loosely-confined straight waveguides 112, 122 and the adiabatic waveguide mode-converters 114, 124 may be selected (within or outside the above-noted ranges) to suit a particular purpose.

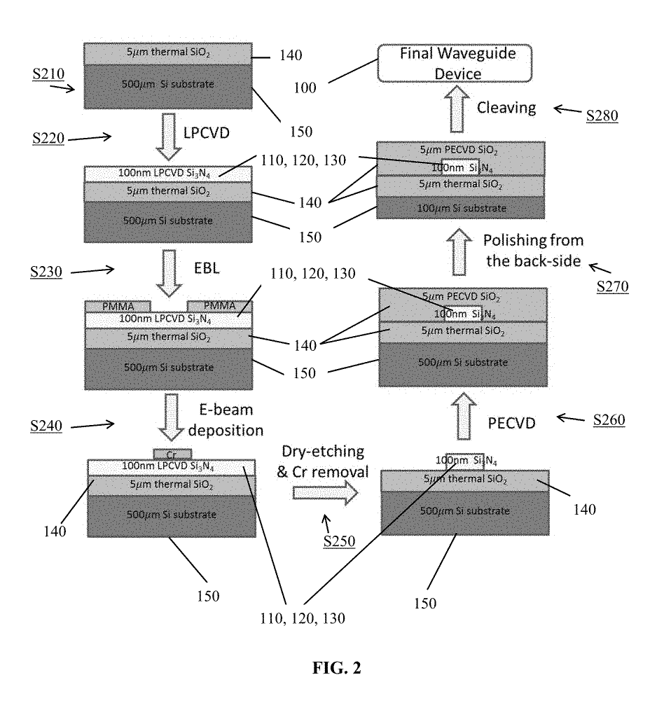

Turning to FIG. 2, fabrication of the integrated chip optical waveguide 100 is described. The fabrication starts, at S210, with silicon substrate 150 having a thermal SiO2 layer, the lower cladding layer 140, disposed thereon. The silicon substrate 150 may define an initial thickness of about 500 μm; the thermal SiO2 cladding layer 140 may define a thickness of about 5 μm. At S220, an Si3N4 layer is deposited onto the thermal SiO2 layer using low-pressure chemical vapor deposition (LPCVD) to form the waveguide core 130 and the first and second waveguide couplers 110, 120 (which are also formed from Si3N4).

The Si3N4 layer may have a thickness of about 100 nm, although other thicknesses may also be provided, depending upon the particular application. As indicated at S230, the shape of the waveguide core 130 and waveguide couplers 110, 120 is defined by electron-beam (e-beam) lithography. Alternatively, the loosely-confined straight waveguide portions 112, 122 (and/or the waveguide core 130 and/or adiabatic waveguide mode-converters 114, 124) may be patterned via deep-UV lithography, which would lead to higher yield as compared to e-beam lithography.

At S240, a 10 nm thick chromium (Cr) hard mask is deposited by e-beam deposition followed by a lift-off process. In other embodiments, other metal or photoresist masks can also be used. Reactive-ion etching (ME) is performed at S250 and the chromium mask is removed, followed by, at S260, another SiO2 layer (of, e.g., 5 nm), the upper cladding layer 140, deposited by plasma-enhanced chemical vapor deposition (PECVD).

The Si substrate 150 is polished down, at S270, from the bottom side thereof, from the original about 500 nm to about 100 nm for ease of cleaving. This may be accomplished using a lapping jig. To achieve the final integrated chip optical waveguide 100, as indicated at S280, the waveguide couplers 110, 120 are cleaved at the free ends of the loosely-confined straight waveguides 112, 122 (FIG. 1) thereof. As detailed above, the waveguide couplers 110, 120 provide a cleaving position tolerance of +200 nm, or better.

As an alternative to polishing down the Si substrate 150 prior to cleaving, cleaving may be performed first; or no polishing may be performed at all. Direct cleaving without polishing saves time and reduces the complexity of the fabrication process. A 500 nm thick waveguide sample is also much more robust than a 100 μm waveguide sample obtained after back-side polishing.

In order to demonstrate the coupling efficiency of the waveguide coupler of the present disclosure, simulation and experimentation were performed. Simulation was performed using FIMMPROP™, a software commercially-available by Photon Design, Ltd. of Oxford, UK.

In the simulation, coupling efficiency was calculated by performing the integrals of the field overlap between the fiber mode and the waveguide mode. In order to get a high coupling efficiency, a high numerical aperture (NA) UHNA3 fiber with a small mode size of 4.1 μm at the wavelength of 1550 nm was used for butt-coupling with the coupler.

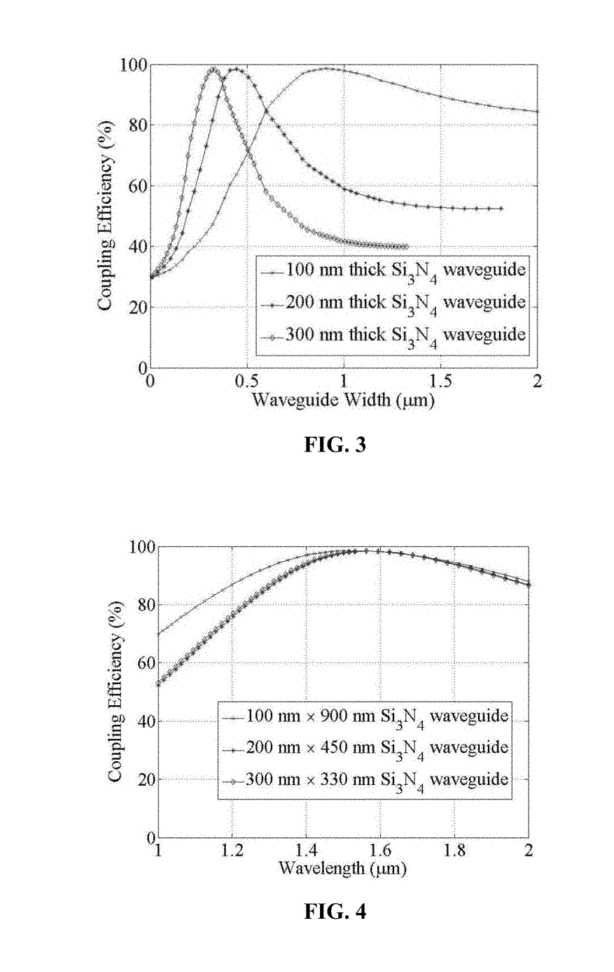

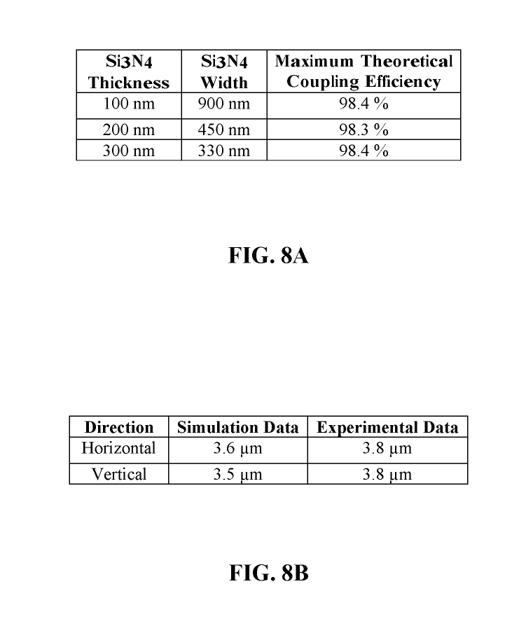

FIG. 3 illustrates the theoretical coupling efficiency of the coupler of the present disclosure, as determined from the simulation, between the UHNA3 fiber and an Si3N4/SiO2 waveguide with different waveguide width and thickness geometries. The mode studied was the fundamental mode of the Si3N4/SiO2 waveguide, which is a TE mode with a small mode size, a high effective index, and a lower propagation loss. The thicknesses of the top and bottom cladding were both 5 μm in the simulation. Three different Si3N4 core thicknesses (100 nm, 200 nm, and 300 nm) were studied, and for each thickness the coupling efficiency was plotted by varying the Si3N4 core width, as illustrated in FIG. 3. According to the simulation results, an ultra-high theoretical coupling efficiency of 98% was obtained using the coupler of the present disclosure between the UHNA3 fiber and the Si3N4/SiO2 waveguide for all three thicknesses; although the maximum coupling efficiency happened at different waveguide widths for each thickness. The maximum theoretical coupling efficiencies at a wavelength of 1550 nm, as determined by the simulation, are provided in FIG. 8A.

The coupling efficiencies versus wavelengths for each of the maximum theoretical coupling efficiency geometries noted above are plotted in FIG. 4.

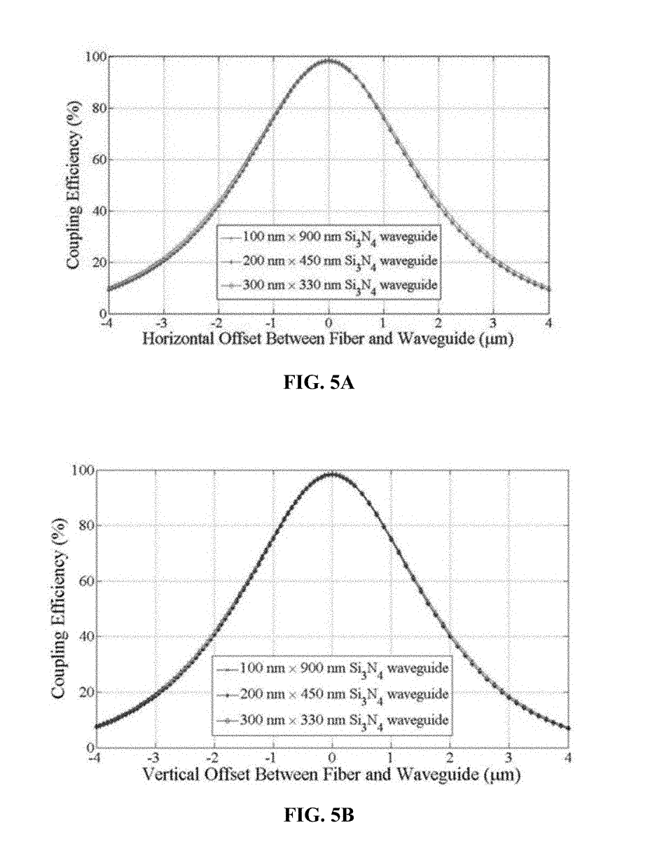

Another important feature, as detailed above, is the ability of the disclosed coupler to provide greater alignment tolerances. The alignment tolerance between the fiber and the coupler was defined as the 3-dB width (FWHM) in a plot of the coupling efficiency versus the displacement in the x- and y-directions. This parameter indicates whether the coupling efficiency will drop substantially or not when the center of the fiber is moved horizontally or vertically with respect to the coupler. A large alignment tolerance means that even if the position of the fiber changes by a few microns, a good coupling efficiency (3 dB change) can still be maintained. FIGS. 5A and 5B respectively illustrate the horizontal and vertical alignment tolerances between the UHNA3 fiber and the coupler of the present disclosure (implemented in an Si3N4 waveguide). It was found that the theoretical alignment tolerances were almost the same for all the three waveguide geometries, as illustrated in FIGS. 5A and 5B.

In addition to the above-detailed simulations, an experiment was also conducted to verify the simulations. The experiment set-up utilized two XYZ translation stages, each holding a fiber for butt-coupling on both sides of the coupler of the present disclosure. Two measurement methods were used. In the first method, a Superluminescent Diode (SLD) broadband light source (Thorlabs S5FC1550P-A2) was used as the light source and a 3-paddle fiber polarization controller (PC) was used to control the polarization of the input light to the TE mode. An output fiber was butt-coupled to the other side of the coupler for maximum power output. An Optical Spectral Analyzer (OSA) was used to record the transmission spectrum of the waveguide coupler. In the second measurement method, a tunable laser and a power meter were used instead of the SLD broadband light source and the OSA. Both setups gave the same results for coupling efficiency.

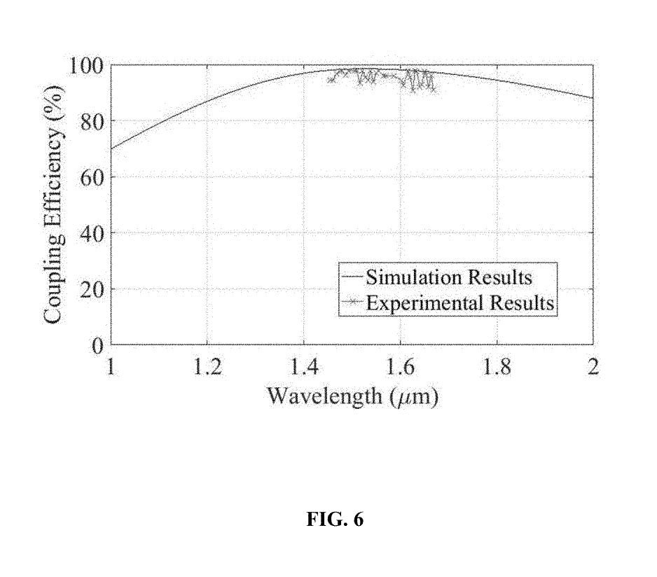

To measure the coupling efficiency of the coupler of the present disclosure, the through-put of two perfectly cleaved and aligned fibers (without the coupler in the middle) was measured, which represents the reference level for the fiber-to-fiber transmission. Then the integrated chip optical waveguide (including the couplers) of the present disclosure was positioned between the two fibers, and the light was coupled into and out of the waveguide by carefully adjusting the input and output fibers for maximum transmission. The difference between the fiber-to-fiber transmission and the fiber-waveguide-fiber transmission includes the coupling losses from both facets plus the propagation loss. To find out the coupling efficiency, waveguide with different lengths of 5 mm, 10 mm, and 15 mm were fabricated and cleaved. FIG. 6 illustrates the experimental coupling efficiency (as well as the simulation coupling efficiency) versus wavelength between the UHNA3 fiber and the 100 nm thick×900 nm wide Si3N4 waveguide. The wavelength dependence was measured from 1450 nm to 1650 nm. The experimental coupling efficiency was 96% at the central wavelength of 1550 nm, and was >90% for the entire spectral range from 1450 nm to 1650 nm. These results thus agree with the simulation data detailed above.

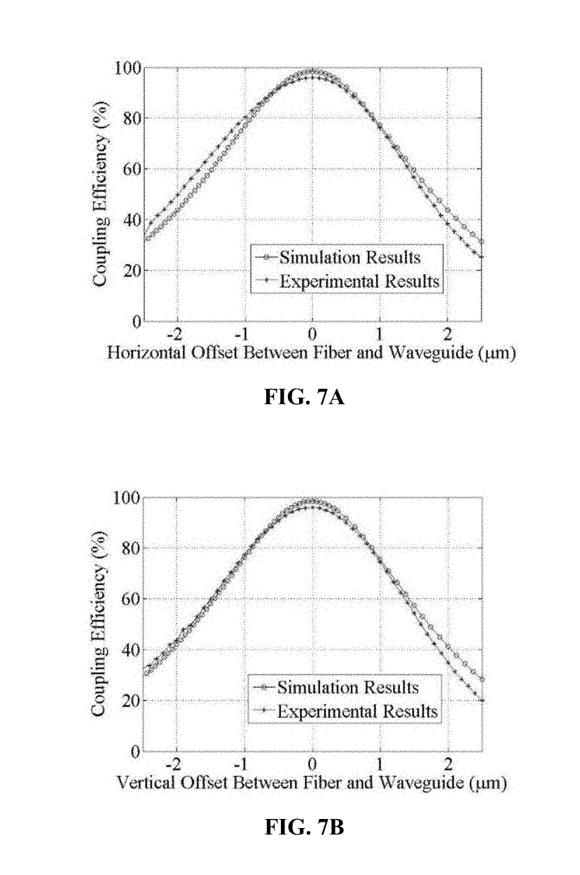

FIGS. 7A and 7B illustrate the alignment tolerances between the fiber and the waveguide according to experimentation (as well as the simulation results). The coupling was first set for maximum transmission and then the fiber position was offset both horizontally and vertically. The experimental and simulation alignment tolerances are provided in FIG. 8B.

As demonstrated above, the couplers and waveguides including the same of the present disclosure provide a high coupling efficiency of 98% in theory and 96% in experiment performed at a wavelength of 1550 nm. Such couplers and waveguides also provide minimal sensitivity to end-facet cleaving position and large fiber-to-waveguide alignment tolerances in both the vertical and horizontal directions.

The following bibliographic documents and papers are incorporated herein by reference in their entireties:

Kenneth O Hill, B Malo, F Bilodeau, D C Johnson, and J Albert. Bragg gratings fabricated in monomode photosensitive optical fiber by uv exposure through a phase mask. Applied Physics Letters, 62(10):1035-1037, 1993.

Andreas Othonos. Fiber bragg gratings. Review of Scientific Instruments, 68(12):4309-4341, 1997.

Raman Kashyap. Fiber bragg gratings. Academic press, 1999.

Andreas Othonos and Kyriacos Kalli. Fiber Bragg gratings: fundamentals and applications in telecommunications and sensing. Artech House, 1999.

Thomas Edward Murphy, Je□rey Todd Hastings, and Henry I Smith. Fabrication and characterization of narrow-band Bragg-reflection filters in silicon-on-insulator ridge waveguides. Journal of Lightwave Technology, 19(12):1938, 2001.

Graham D Marshall, Martin Ams, and Michael J Withford. Direct laser written waveguide-bragg gratings in bulk fused silica. Optics Letters, 31(18):2690-2691, 2006.

Xu Wang, Wei Shi, Han Yun, Samantha Grist, Nicolas A F Jaeger, and Lukas Chrostowski. Narrow-band waveguide bragg gratings on soi wafers with cmos-compatible fabrication process. Optics Express, 20(14):15547-15558, 2012.

J Bland-Hawthorn, A Buryak, and K Kolossovski. Optimization algorithm for ultrabroadband multichannel aperiodic fiber Bragg grating filters. JOSA A, 25(1):153-158, 2008.

P Rousselot, C Lidman, J-G Cuby, G Moreels, and G Monnet. Night-sky spectral atlas of OH emission lines in the near-infrared. Astronomy and Astro-physics, 354:1134-1150, 2000.

Tiecheng Zhu, Yiwen Hu, Pradip Gatkine, Sylvain Veilleux, Joss Bland-Hawthorn, and Mario Dagenais. Arbitrary on-chip optical filter using complex waveguide bragg gratings. Applied Physics Letters, 108(10):101104, 2016.

Bruno Badoil, Fabien Lemarchand, Michel Cathelinaud, and Michel Lequime. Interest of broadband optical monitoring for thin-film filter manufacturing. Applied Optics, 46(20):4294-4303, 2007.

J Bland-Hawthorn, S C Ellis, S G Leon-Saval, R Haynes, M M Roth, H-G L\ddot{}ohmannsr\ddot{}oben, A J Horton, J-G Cuby, Tim A Birks, J S Lawrence, et al. A complex multi-notch astronomical filter to suppress the bright infrared sky. Nature Communications, 2:581, 2011.

S C Ellis, J Bland-Hawthorn, J Lawrence, A J Horton, C Trinh, S G Leon-Saval, K Shortridge, J Bryant, S Case, M Colless, et al. Suppression of the near-infrared OH night-sky lines with fibre Bragg gratings—first results. Monthly Notices of the Royal Astronomical Society, 425(3):1682-1695, 2012.

Christopher Q Trinh, Simon C Ellis, Joss Bland-Hawthorn, Anthony J Horton, Jon S Lawrence, and Sergio G Leon-Saval. The nature of the near-infrared interline sky background using fibre Bragg grating OH suppression. Monthly Notices of the Royal Asfronomical Society, 432(4):3262-3277, 2013.

Christopher Q Trinh, Simon C Ellis, Joss Bland-Hawthorn, Jon S Lawrence, Anthony J Horton, Sergio G Leon-Saval, Keith Shortridge, Julia Bryant, Scott Case, Matthew Colless, et al. GNOSIS: the first instrument to use fiber Bragg gratings for OH suppression. The Astronomical Journal, 145(2):51, 2013.

Gu\ddot{}nter Steinmeyer. A review of ultrafast optics and optoelectronics. Journal of Optics A: Pure and Applied Optics, 5(1):R1, 2003.

Ian W Frank, Yinan Zhang, and Marko Loncar. Nearly arbitrary on-chip optical filters for ultrafast pulse shaping. Optics Express, 22(19):22403-22410, 2014.

Thomas F Krauss. Why do we need slow light? Nature Photonics, 2(8):448-450, 2008.

Johannes Skaar, Ligang Wang, and Turan Erdogan. On the synthesis of fiber bragg gratings by layer peeling. Quantum Electronics, IEEE Journal of 37(2):165-173, 2001.

Ricardo Feced, Michalis N Zervas, and Miguel A Muriel. An efficient inverse scattering algorithm for the design of nonuniform fiber bragg gratings. Quantum Electronics, IEEE Journal of 35(8):1105-1115, 1999.

A Buryak, J Bland-Hawthorn, and V Steblina. Comparison of inverse scattering algorithms for designing ultrabroadband fibre bragg gratings. Optics Express, 17(3):1995-2004, 2009.

Marie Verbist, Dries Van Thourhout, and Wim Bogaerts. Weak gratings in silicon-on-insulator for spectral filters based on volume holography. Optics Letters, 38(3):386-388, 2013.

Marie Verbist, Wim Bogaerts, and Dries Van Thourhout. Design of weak 1-D Bragg grating filters in SOI waveguides using Volume Holography techniques. Journal of Lightwave Technology, 32(10):1915-1920, 2014.

Johannes Skaar. Synthesis and characterization of fiber Bragg gratings. Citeseer, 2000.

Turan Erdogan. Fiber grating spectra. Journal of lightwave technology, 15(8):1277-1294, 1997.

Leon Poladian Resonance mode expansions and exact solutions for nonuniform gratings. Physical Review E, 54(3):2963, 1996.

Allan W Snyder and John Love. Optical waveguide theory. Springer Science & Business Media, 2012.

Amnon Yariv and Pochi Yeh. Photonics: optical electronics in modern communications (the oxford series in electrical and computer engineering). Oxford University Press, Inc., 2006.

Johannes Skaar and Ole Henrik Waagaard. Design and characterization of finite-length fiber gratings. IEEE Journal of Quantum Electronics, 39(10):1238-1245, 2003.

Geo□Erey A Cranch and Gordon M H Flockhart. Tools for synthesising and characterising Bragg grating structures in optical fibres and waveguides. Journal of Modern Optics, 59(6):493-526, 2012.

Charles H Henry, R F Kazarinov, H J Lee, K J Orlowsky, and L E Katz Low loss Si3N4-SiO2 optical waveguides on Si. Applied Optics, 26(13):2621-2624, 1987.

G Grand, J P Jadot, H Denis, S Valette, A Fournier, and A M Grouillet. Low-loss PECVD silica channel waveguides for optical communications. Electronics Letters, 26(25):2135-2137, 1990.

R R Thomson, Tim A Birks, S G Leon-Saval, A K Kar, and J Bland-Hawthorn. Ultrafast laser inscription of an integrated photonic lantern. Optics Express, 19(6):5698-5705, 2011.

Izabela Spaleniak, Simon Gross, Nemanja Jovanovic, Robert J Williams, Jon S Lawrence, Michael J Ireland, and Michael J Withford. Multiband processing of multimode light: combining 3D photonic lanterns with waveguide Bragg gratings. Laser & Photonics Reviews, 8(1):L1-L5, 2014.

Martijn J R Heck, Jared F Bauters, Michael L Davenport, Daryl T Spencer, and John E Bowers. Ultra-low loss waveguide platform and its integration with silicon photonics. Laser & Photonics Reviews, 8(5):667-686, 2014.

David J Moss, Roberto Morandotti, Alexander L Gaeta, and Michal Lipson. New cmos-compatible platforms based on silicon nitride and hydex for nonlinear optics. Nature Photonics, 7(8):597-607, 2013.

Hongchen Yu, Minghua Chen, Qiang Guo, Marcel Hoekman, Hongwei Chen, Arne Leinse, Rene G Heideman, Richard Mateman, Sigang Yang, and Shizhong Xie. Si 3 n 4-based integrated optical analog signal processor and its application in if photonic frontend. Photonics Journal, IEEE, 7(5):1-9, 2015.

Leimeng Zhuang, David Marpaung, Maurizio Burla, Willem Beeker, Arne Leinse, and Chris Roelo□zen. Low-loss, high-index-contrast si 3 n 4/sio 2 optical waveguides for optical delay lines in microwave photonics signal processing. Optics Express, 19(23):23162-23170, 2011.

Vittorio M N Passaro, Mario La Notte, Benedetto Troia, Lorenzo Passaquindici, Francesco De Leonardis, and Giovanni Giannoccaro. Photonic structures based on slot waveguides for nanosensors: State of the art and future developments. Int. J. Res. Rev. Appl. Sci, 11(3):402-418, 2012.

Gu\ddot{}nay urtsever, Boris Pova\check{}zay, Aneesh Alex, Behrooz Zabihian, Wolfgang Drexler, and Roel Baets. Photonic integrated mach-zehnder interferometer with an on-chip reference arm for optical coherence tomography. Biomedical Optics Express, 5(4):1050-1061, 2014.

J\ddot{}orn P Epping, Tim Hellwig, Marcel Hoekman, Richard Mateman, Arne Leinse, Ren´e G Heideman, Albert van Rees, Peter J M van der Slot, Chris J Lee, Carsten Fallnich, et al. On-chip visible-to-infrared supercontinuum generation with more than 495 thz spectral bandwidth. Optics Express, 23(15):19596-19604, 2015.

Jared F Bauters, Martijn J R Heck, Demis John, Daoxin Dai, Ming-Chun Tien, Jonathon S Barton, Arne Leinse, Ren´e G Heideman, Daniel J Blumenthal, and John E Bowers. Ultra-low-loss high-aspect-ratio Si3N4 waveguides. Optics Express, 19(4):3163-3174, 2011.

Jared F Bauters, Martijn J R Heck, Demis D John, Jonathon S Barton, Christiaan M Bruinink, Arne Leinse, Ren´e G Heideman, Daniel J Blumenthal, and John E Bowers. Planar waveguides with less than 0.1 db/m propagation loss fabricated with wafer bonding. Optics Express, 19(24):24090-24101, 2011.

Christopher R Doerr, Long Chen, Young-Kai Chen, and Larry L Buhl. Wide bandwidth silicon nitride grating coupler. IEEE Photonics Technology Letters, 22(19):1461-1463, 2010.

A Z Subramanian, Pieter Neutens, Ashim Dhakal, Roelof Jansen, Tom Claes, Xavier Rottenberg, Fr´ed´eric Peyskens, Shankar Selvaraja, Philippe Helin, Bert Dubois, et al. Low-loss singlemode PECVD silicon nitride photonic wire waveguides for 532-900 nm wavelength window fabricated within a CMOS pilot line. Photonics Journal, IEEE, 5(6):2202809-2202809, 2013.

Huijuan Zhang, Chao Li, Xiaoguang Tu, Junfeng Song, Haifeng Zhou, Xianshu Luo, Ying Huang, Mingbin Yu, and GQ Lo. Efficient silicon nitride grating coupler with distributed Bragg reflectors. Optics Express, 22(18):21800-21805, 2014.

Wesley D Sacher, Ying Huang, Liang Ding, Benjamin J F Taylor, Hasitha Jayatilleka, Guo-Qiang Lo, and Joyce K S Poon. Wide bandwidth and high coupling efficiency Si3N4-on-SOI dual-level grating coupler. Optics Express, 22(9):10938-10947, 2014

Wissem Sfar Zaoui, Andreas Kunze, Wolfgang Vogel, Manfred Berroth, J\ddot{}org Butschke, Florian Letzkus, and Joachim Burghartz. Bridging the gap between optical fibers and silicon photonic integrated circuits. Optics Express, 22(2):1277-1286, 2014.

S H Tao, Junfeng Song, Qing Fang, Mingbin Yu, Guoqiang Lo, and Dim-lee Kwong. Improving coupling efficiency of fiber-waveguide coupling with a double-tip coupler. Optics Express, 16(25):20803-20808, 2008.

T G Tiecke, K P Nayak, J D Thompson, T Peyronel, N P de Leon, V Vuleti´c, and M D Lukin Efficient fiber-optical interface for nanophotonic devices. Optica, 2(2):70-75, 2015.

FIMMWAVE/FIMMPROP by Photon Design Ltd., http://www.photond.com.

Application note nuapp-3: Uhna fiber efficient coupling to silicōn waveguides. Nufern Inc http://www.nufern.com/pam/optical fibers/984/UHNA3/.

T Shoji, T Tsuchizawa, T Watanabe, K Yamada, and H Morita. Low loss mode size converter from 0.3 μm square si wire waveguides to singlemode fibres. Electronics Letters, 38(25):1669-1670, 2002.

Jaime Cardenas, Carl B Poitras, Kevin Luke, Lian-Wee Luo, Paul Adrian Morton, and Michal Lipson. High coupling efficiency etched facet tapers in silicon waveguides. IEEE Photonics Technol. Lett, 26(23):2380-2382, 2014.

Victor Nguyen, Trisha Montalbo, Christina Manolatou, Anu Agarwal, Ching-yin Hong, John Yasaitis, L C Kimerling, and Jurgen Michel. Silicon-based highly-efficient fiber-to-waveguide coupler for high index contrast systems. Applied Physics Letters, 88(8):081112, 2006.

Long Chen, Christopher R Doerr, Young-Kai Chen, and Tsung-Yang Liow. ow-Loss and Broadband Cantilever Couplers Between Standard Cleaved Fibers and High-Index-Contrast Si N or Si Waveguides. Photonics Technology Letters, IEEE, 22(23):1744-1746, 2010.

F Ay and A Aydinli Comparative investigation of hydrogen bonding in silicon based PECVD grown dielectrics for optical waveguides. Optical Materials, 26(1):33-46, 2004.

Daoxin Dai, Zhi Wang, Jared F Bauters, M-C Tien, Martijn JR Heck, Daniel J Blumenthal, and John E Bowers. Low-loss Si3N4 arrayed-waveguide grating (de) multiplexer using nano-core optical waveguides. Optics Express, 19 (15): 14130-14136, 2011.

Pradip Gatkine, Sylvain Veilleux, Yiwen Hu, Tiecheng Zhu, Yang Meng, Joss Bland-Hawthorn, and Mario Dagenais. Development of high-resolution arrayed waveguide grating spectrometers for astronomical applications: first results, 2016.

Tiecheng Zhu, Yiwen Hu, Pradip Gatkine, Sylvain Veilleux, Joss Bland-Hawthorn, and Mario Dagenais. “Arbitrary on-chip optical filter using complex waveguide Bragg gratings.” Applied Physics Letters 108, no. 10 (2016): 101104.

Tiecheng Zhu, Yi-Wen Hu, Pradip Gatkine, Sylvain Veilleux, Joss Bland-Hawthorn, and Mario Dagenais. “Ultra-broadband High Coupling Efficiency Fiber-to-Waveguide Coupler Using Si3N4/SiO2 Waveguides On Silicon.” IEEE Photonics Journal, vol. 8, no. 5, pp. 1-12, October 2016.

Pradip Gatkine, Sylvain Veilleux, Yiwen Hu, Tiecheng Zhu, Yang Meng, Joss Bland-Hawthorn, and Mario Dagenais. “Development of high resolution arrayed waveguide grating spectrometers for astronomical applications: first results.” arXiv preprint arXiv:1606.02730 (2016).

Tiecheng Zhu, Sylvain Veilleux, and Mario Dagenais, “Si3N4/SiO2 on Si Nanophotonics for Arbitrary Optical Filters and High Efficiency Couplers.” Optical Society of America (OSA) Photonics North, 2016

Tiecheng Zhu, Sylvain Veilleux, Joss Bland-Hawthorn, and Mario Dagenais. “Ultra-broadband High Coupling Efficiency Using a Si 3 N 4/5i02 waveguide on silicon.” Photonics Society Summer Topical Meeting Series (SUM), 2016 IEEE, pp. 92-93. IEEE, 2016.

Tiecheng Zhu, Sylvain Veilleux, Joss Bland-Hawthorn, and Mario Dagenais. “Complex Waveguide Bragg Gratings For arbitrary spectral filtering.” Photonics Society Summer Topical Meeting Series (SUM), 2016 IEEE, pp. 211-212. IEEE, 2016.

Tiecheng Zhu, Sylvain Veilleux, Joss Bland-Hawthorn, and Mario Dagenais. “Ultra high coupling efficiency from a single mode fiber to a high index contrast on-chip waveguide and complex waveguide Bragg gratings for spectral filtering.” 2015 IEEE Summer Topicals Meeting Series (SUM), pp. 19-20. IEEE, 2015.

While several embodiments and methodologies of the present disclosure have been described and shown in the drawings, it is not intended that the present disclosure be limited thereto, as it is intended that the present disclosure be as broad in scope as the art will allow and that the specification be read likewise. Therefore, the above description should not be construed as limiting, but merely as exemplifications of particular embodiments and methodologies. Those skilled in the art will envision other modifications within the scope of the claims appended hereto.

What is claimed is:

1. A coupler for coupling a single-mode optical fiber to a single-mode on-chip optical waveguide, comprising:
a loosely-confined straight waveguide portion defining a first end configured for positioning adjacent an optical fiber, and a second end; and
an adiabatic waveguide mode-converter extending from a first end thereof at the second end of the loosely-confined straight waveguide portion to a second end thereof, the second end of the adiabatic waveguide mode-converter configured for positioning adjacent a more-confined waveguide core, the adiabatic waveguide converter tapering from the second end to the first end thereof and configured to serve as a transition between the loosely-confined straight waveguide portion and the more-confined waveguide core.

2. The coupler according to claim 1, wherein the coupler exhibits a coupling efficiency of at least 96%.

3. The coupler according to claim 1, wherein the loosely-confined straight waveguide portion maintains efficiency within a cleave position range of ±200 μm.

4. The coupler according to claim 1, wherein the coupler defines at least one of a vertical alignment tolerance or a horizontal alignment tolerance of at least 3.8 μm.

5. The coupler according to claim 1, wherein the loosely-confined straight waveguide portion and the adiabatic waveguide mode-converter are formed from Si3N4.

6. The coupler according to claim 5, wherein the loosely-confined straight waveguide portion and the adiabatic waveguide mode-converter are disposed between top and bottom SiO2 cladding layers.

7. The coupler according to claim 6, wherein the bottom SiO2 cladding layer is disposed on an Si substrate.

8. An integrated chip single-mode optical waveguide, comprising:
a more-confined waveguide core; and
a first coupler disposed at an end of the more-confined waveguide core, the first coupler including:
a loosely-confined straight waveguide portion defining a first end configured for positioning adjacent an input optical fiber, and a second end; and
an adiabatic waveguide mode-converter extending from a first end thereof at the second end of the loosely-confined straight waveguide portion to a second end thereof at an end of the more-confined waveguide core, the adiabatic waveguide converter tapering from the second end to the first end thereof and configured to serve as a transition between the loosely-confined straight waveguide portion and the more-confined waveguide core.

9. The integrated chip single-mode optical waveguide according to claim 8, wherein the first coupler exhibits a coupling efficiency of at least 96%.

10. The integrated chip single-mode optical waveguide according to claim 8, wherein the loosely-confined straight waveguide portion maintains efficiency within a cleave position range of +200 μm.

11. The integrated chip single-mode optical waveguide according to claim 8, wherein the first coupler defines at least one of a vertical alignment tolerance or a horizontal alignment tolerance of at least 3.8 μm.

12. The integrated chip single-mode optical waveguide according to claim 8, wherein the waveguide core and the first coupler are formed from Si3N4.

13. The integrated chip single-mode optical waveguide according to claim 12, wherein the waveguide core and the first coupler are disposed between top and bottom SiO2 cladding layers.

14. The integrated chip single-mode optical waveguide according to claim 13, wherein the bottom SiO2 cladding layer is disposed on an Si substrate.

15. The integrated chip single-mode optical waveguide according to claim 8, further comprising a second coupler disposed at an opposite end of the waveguide core, the second coupler including:
a loosely-confined straight waveguide portion defining a first end configured for positioning adjacent an output optical fiber, and a second end; and
an adiabatic waveguide mode-converter extending from a first end thereof at the second end of the loosely-confined straight waveguide portion to a second end thereof at the opposite end of the more-confined waveguide core, the adiabatic waveguide converter tapering from the second end to the first end thereof and configured to serve as a transition between the loosely-confined straight waveguide portion and the more-confined waveguide core.

16. A system, comprising:
an input optical fiber;
an output optical fiber; and
an integrated chip single-mode optical waveguide disposed between the input optical fiber and the output optical fiber, the integrated chip single-mode optical waveguide including:
a more-confined waveguide core; and
first and second couplers, the first coupler disposed between the input optical fiber and the more-confined waveguide core and the second coupler disposed between the output optical fiber and the more-confined waveguide core, each of the first and second couplers including:
a loosely-confined straight waveguide portion defining a first end configured for positioning adjacent the corresponding optical fiber, and a second end; and
an adiabatic waveguide mode-converter extending from a first end thereof at the second end of the loosely-confined straight waveguide portion to a second end thereof at a corresponding end of the more-configured waveguide core, the adiabatic waveguide converter tapering from the second end to the first end thereof and configured to serve as a transition between the loosely-confined straight waveguide portion and the more-confined waveguide core.

17. The system according to claim 16, wherein each coupler exhibits a coupling efficiency of at least 96%.

18. The system according to claim 16, wherein the loosely-confined straight waveguide portions of the first and second couplers maintain efficiency within a cleave position range of ±200 μm.

19. The system according to claim 16, wherein the first and second couplers defines at least one of a vertical alignment tolerance or a horizontal alignment tolerance of at least 3.8 μm relative to the corresponding optical fiber disposed adjacent thereto.

20. The system according to claim 16, wherein:
the waveguide core and the first and second couplers are formed from Si3N4,
the waveguide core and the first and second couplers are disposed between top and bottom SiO2 cladding layers; and
the bottom SiO2 cladding layer is disposed on an Si substrate.
